(19) United States
(12) Patent Application Publication
(10) Pub. No.: US 2008/0298332 A1
(43) Pub. Date: Dec. 4, 2008

(54) PACKET DATA COMMUNICATION METHOD, RADIO BASE STATION AND CONTROL STATION

(75) Inventor: Akihisa ERAMI, Fukuoka (JP)

Correspondence Address: MYERS WOLIN, LLC, 100 HEADQUARTERS PLAZA, North Tower, 6th Floor, MORRISTOWN, NJ, 07960-6834, US

(73) Assignee: FUJITSU LIMITED, Kawasaki-shi (JP)

(21) Appl. No.: 12/125,050

(22) Filed: May 21, 2008

(30) Foreign Application Priority Data
May 31, 2007 (JP) 2007-144935

(51) Int. Cl. H04Q 7/24

(52) U.S. Cl. 370/338

(57) ABSTRACT

A packet data communication method including a radio base station receiving packet data from a mobile terminal, and generating a data frame having a packet frame error detection code and transmitting to a control station. The control station detects an error in a packet frame contained in the data frame based on the error detection code. Packet frames with no error detected therein are separated, while a sequence number of the packet frame with an error detected therein is detected. The packet frames are arranged in order of sequence number, and the arrival of a packet frame having a missing sequence number is awaited. After a waiting period packet frames, other than those with an error detected therein, are arranged in continuous order by sequence numbers.

### CROSS-REFERENCE TO RELATED APPLICATION

This application is based upon and claims the benefit of priority of the prior Japanese Patent Application No. 2007-144935, filed on May 31, 2007, the entire contents of which are incorporated herein by reference.

### BACKGROUND OF THE INVENTION

1. Field of the Invention

The embodiments relate to a packet data communication method, a radio base station and a control station of a mobile communication system. In particular, the embodiments relate to a packet data communication method, a radio base station and a control station for dealing with a transmission loss generated between the radio base station and the control station in HSUPA (High Speed Uplink Packet Access) that is an uplink high-speed packet communication in a third-generation mobile communication system.

2. Description of the Related Art

HSUPA is one of the techniques for realizing uplink high-speed packet transmission in a third-generation (3G) mobile communication system. HSUPA is standardized according to the Release 6 standard issued by the standardization project 3GPP (3rd-Generation Partnership Project) for preparing the specification of the third-generation system. According to HSUPA, the process of a new MAC (Media Access Control) layer is specified in addition to a new specification about a physical channel between a mobile terminal and a radio base station (see, for example, Non-patent Document: 11 3rd-Generation Partnership Project; Technical Specification Group Radio Access Network; FDD Enhanced Uplink; Overall description (Release 6) 3GPP TS25.309).

FIG. 1 is a diagram for explaining the outline of data processing according to HSUPA.

The left side of FIG. 1 shows the process executed in the MAC layer of a radio base station and a control station for receiving uplink data from a mobile terminal. The right side of FIG. 1, on the other hand, shows the unit of data (Protocol Data Unit: PDU) to be executed in each process shown on the left side. The data process in the radio base station and the control station is executed from bottom up in FIG. 1. Specifically, the data process in the radio base station and the control station is executed sequentially toward a high-ranking radio link control (RLC) layer from a layer 1 constituting a physical layer. The data format is also changed from bottom upward sequentially in FIG. 1. In FIG. 1, the data processing of the MAC-e layer is performed by the radio base station connected to the mobile terminal by radio communication. The data process in the layers higher than MAC-es is executed by the control station connected to the radio base station by wired communication.

Data in the mobile terminal, conversely to the data in the radio base station and the control station described above, is sequentially changed top down in FIG. 1 with the process execution. Specifically, in the radio link control layer (RLC) higher than the MAC layer, IP packet data is divided into data 101 of a fixed length. Next, a header 102 is added to the data 101 thereby to generate RLC_PDU 103. The RLC_PDU 103 is supplied to the MAC layer as MAC-d_PDU 104. The RLC-PDU 103 (MAC-d_PDU 104) is supplied for each of a plurality of traffic flows, if any, indicated as a plurality of DTCH (Dedicated Transfer Channels), for example, in the event that a mail is transmitted during audio transmission with VoIP (Voice over IP) in a single mobile terminal. A plurality of MAC-d_PDU's 104 are multiplexed for each traffic flow thereby to generate MAC-es_PDU 105 (hereinafter referred to as MAC-es frame 105) as a packet frame. In each MAC-es frame 105, a continuous sequence number (transmission serial number: TSN) 106 of 0 to 63 is inserted in the order of generation thereof. Incidentally, the sequence number 106 is assigned independently for each traffic flow associated with the MAC-es frame 105. Further, a plurality of MAC-es frames are multiplexed to generate MAC-e_PDU 110 (hereinafter referred to as MAC-e frame 110). As a result, the MAC-e frame 110 adapted for a plurality of data flows including VoIP data and mail data is generated by multiplexing. The MAC-e frame 110 is transmitted to the radio base station by radio communication through the low-ranking physical layer (Layer 1).

Next, the data processing in the radio base station and the control station are explained in the order bottom up on both left and right sides of FIG. 1.

In the radio base station, the MAC-e frame 110 transmitted by the mobile terminal is obtained from the physical layer (Layer 1) underlying the MAC layers. In HSUPA, data from a given one mobile terminal is received not necessarily by one radio base station, but the data from one mobile terminal is received in parallel by a plurality of radio base stations communicable with the particular mobile terminal. In the radio section between the mobile terminal and each radio base station, the transmission is confirmed for each MAC-e frame 110. More specifically, an automatic retransmission process 121 (Hybrid Automatic Repeat ReQuest: HARQ) (hereinafter referred to as the HARQ process 121) of the radio base station detects an error. The HARQ process 121, upon detection of an error, requests the mobile terminal to repeat the transmission for each MAC-e frame 110. As a result, the drop-off of data sent to each radio base station through the radio section is suppressed. In the radio base station, a plurality of MAC-es frames 105 are demultiplexed by a demultiplexing process 122 from an error-free MAC-e frame 110 that has arrived at the radio base station. The demultiplexed MAC-es frames 105 are sent to the control station. In the process of transmission to the control station, an enhanced data channel frame protocol frame (E-DCH_FP frame) (hereinafter also referred to as the FP frame) is formed as a data frame including a plurality of MAC-es frames 105 accumulated for a predetermined length of time. This FP frame is sent to the control station at regular time intervals. In the control station, the FP frame thus sent thereto is separated into a plurality of MAC-es frames. The detailed description at the level of the FP frame is made later, and the description at the level of the MAC-es frame is continued.

The MAC-es frames 105 sent to the control station are subjected to reordering processes 123, 124. In the reordering processes 123, 124, the MAC-es frames 105 are arranged and output in the order of the sequence number for each traffic flow. For example, in the case where a transmission error is detected in the radio section and the data is retransmitted, the sequence numbers of the MAC-es frames 105 sequentially sent to the control station lack the continuity wherein there may be a missing sequence number. That is the sequence number of the frame being retransmitted In such a case, the MAC-es frames that have already arrived are held in a buffer as a reordering queue, and in the reordering processes 123, 124, the arrival of the MAC-es frame having a missing sequence number is awaited. With the arrival of the awaited MAC-es frame, the MAC-es frames are output in the order of the sequence number. After the reordering processes 123, 124, a plurality of MAC-d_PDU's 104, i.e., RLCPDU's 103 are separated from the MAC-es frames 105 by a disassembly process 125. The RLCPDU's 103 separated by the disassembly process 125 are delivered to the high-ranking RLC layer.

FIG. 2 is a block diagram showing an example of a mobile communication system for realizing the data processing shown in FIG. 1.

The mobile communication system 100 shown in FIG. 2 includes a control station 1, a radio base station 2 and a mobile terminal 3. The parts of the mobile communication system 100 shown in FIG. 2 are primarily associated with the process shown in FIG. 1. The mobile terminal 3 and the radio base station 2 are connected to each other in a way wirelessly communicable with each other through Uu physical layer control units 32, 24, respectively. Also, the radio base station 2 and the control station 1 are connected to each other in a wired way communicable with each other through Iub physical layer control units 23, 16, respectively. One skilled in the art would recognize the physical connection between base station 2 and control station 1 may also be wireless.

The mobile terminal 3 includes an RLC protocol unit 30, a multiplexer 31 and a Uu physical layer control unit 32. The radio base station 2 which is a fixed station includes a Uu physical layer control unit 24, an Iub physical layer control unit 23, and as part of unit 2A a demultiplexer 22, an FP frame generating/transmitting unit 21. Also, the control unit 1 includes an Iub physical layer control unit 16, an RLC protocol unit 10, and an HSUPA control unit 1A including an FP frame receiving unit 15, a selective synthesis unit 13, a reordering unit 12, a disassembly unit 11.

The HARQ process 121 shown in FIG. 1 is implemented by the Uu physical layer control unit 24 of the radio base station 2. The demultiplexing process 122 shown in FIG. 1 is realized by the demultiplexer 22 of the radio base station 2. The reordering processes 123, 124 shown in FIG. 1 are realized by the reordering unit 12 of the control station 1. The disassembly process 125 shown in FIG. 1 is realized by the disassembly unit 11 of the control station 1. The HARQ process corresponding to the HARQ process 121 (FIG. 1) on the radio base station 2 side is realized by the Uu physical layer control unit 32 of the mobile terminal 3. The multiplexing process corresponding to the inverse process of the demultiplexing process 122 (FIG. 1) of the radio base station 2 and the multiplexing process corresponding to the inverse process of the disassembly process 125 (FIG. 1) of the control station 1 are realized by the multiplexer 31 of the mobile terminal 3.

The data processing by the mobile communication system shown in FIG. 2 is explained also with reference to FIG. 1. Uplink packet data is transmitted to the multiplexer 31 as MAC-d_PDU 104 from the RLC protocol unit 30 in charge of the process in the high-ranking MAC layers. The multiplexer 31 multiplexes a plurality of pieces of data having the MAC-d_PDU format 104 thereby to generate a MAC-es frame 105. Further, the multiplexer 31 multiplexes a plurality of MAC-es frames 105 thereby to generate a MAC-e frame 110. The plurality of MAC-es frames 105 are each multiplexed after being assigned the serial sequence numbers (TSN) 106.

The MAC-e frame 110 is transmitted to the radio base station 2 from the Uu physical layer control unit 32 by radio communication. The Uu physical layer control unit 32 is in charge of the HARQ process on the mobile terminal 3 side. The Uu physical layer control unit 32 transmits the data at high speed by monopolizing a plurality of physical channels.

The Uu physical layer control unit 24 of the radio base station 2 receives the data transmitted from the mobile terminal 3. The Uu physical layer control unit 24 then confirms the transmission of the MAC-e frame 110 with the mobile terminal 3. Specifically, upon detection of a transmission error in the radio section, a retransmission request is given to the Uu physical layer control unit 32 of the mobile terminal 3. As a result, the requested MAC-e frame 110 is retransmitted from the mobile terminal 3.

The demultiplexer 22 demultiplexes the MAC-e frame 110 received by the Uu physical layer control unit 24 thereby to separate a plurality of MAC-e frames 105.

The FP frame generating/transmitting unit 21 transmits the plurality of MAC-es frames 105 obtained by demultiplex operation of the demultiplexer 22 to the control station 1 in batches at an interval of a predetermined transmission period such as 10 mS. The radio base station 2 receives the MAC-es frame from other mobile terminals in the cells covered by it as well as from the mobile terminal 3 shown in FIG. 2. The FP frame generating/transmitting unit 21 accumulates the MAC-es frame in units of subscribers, i.e. in units of the mobile terminal 3. The FP frame generating/transmitting unit 21 stores the MAC-es frames in the FP frame for each mobile terminal. Each FP frame includes an FP frame header field, a payload field having arranged therein one or a plurality of MAC-es frames and an option field. The FP frame generating/transmitting unit 21 calculates a CRC (cyclic redundancy check) code to detect a transmission error in units of FP frames. The FP frame generating/transmitting unit 21 inserts the calculated CRC code in the corresponding FP frame. Typically an error is liable to be mixed less in the wired section between the radio base station and the control station than in the radio section. According to the 3GPP specification, however, the error detection in the wired section is assured by attaching a CRC 11 to the FP frame header field and a CRC 16 to the tail of the FP frame. The FP frame generating/transmitting unit 21 outputs the FP frame to the Iub physical layer control unit 23 at an interval of a predetermined transmission period.

In the Iub physical layer control unit 23, the FP frame output from the FP frame generating/transmitting unit 21 is transmitted to the control station 1 by wired communication. The interface of the Iub physical layer includes, for example, AAL (ATM adaptation layer) Type 2 (hereinafter referred to as AAL2) of ATM (asynchronous transfer mode). In the mobile communication system employing AAL2, the FP frame is divided into AAL2 cells of a fixed length by the Iub physical layer control unit 23 on the transmission side of the Iub physical layer. The AAL2 thus divided is transmitted by wired communication through an ATM network.

The Iub physical layer control unit 16 of the control station 1 assembles the FP frame from the AAL2 cells sent thereto through the ATM network. The FP frame receiving unit 15 of the control station 1 checks the normalcy of the FP frame. Specifically, based on the payload-CRC inserted in the FP frame, the payload of the FP frame is checked for an error. In the case where no error of the FP frame is detected, the FP frame receiving unit 15 separates the MAC-es frames 105 from the FP frame. Upon detection of an error of the FP frame, on the other hand, the FP frame receiving unit 15 discards the FP frame of which an error has been detected.

FIG. 2 shows only one radio base station 2. Normally, however, one control station 1 is connected with a plurality of radio base stations 2. Each mobile terminal 3 can transmit data to a plurality of radio base stations in parallel. Once the plurality of radio base stations that have received the data from the mobile terminal at the same time transmit the data to the control station, the control station 1 receives, in duplication, the data output from the single mobile terminal 3. The selective synthesis unit 13 excludes the duplication of the MAC-es frames generated by the plurality of radio base stations on the first-come-first-served basis. More specifically, the selective synthesis unit 13, after separating the MAC-es frames by traffic flow, confirms the sequence number of the MAC-es frames. In the case where a sequence number is the same as that of a MAC-es frame previously received, the MAC-es frame having the same sequence number is discarded since the same contents are already received. Thus, even when data is sent in duplication to the control station 1, data free of duplication is transmitted to the reordering unit 12.

The reordering unit 12 waits for the MAC-es frames by traffic flow and rearranges them in the order of the sequence number. Specifically, the MAC-es frames, if received in the right order, are delivered to the disassembly unit 11. In the case where the MAC-es frames received have no continuous serial numbers and have a missing number, the MAC-es frames having the particular missing number and subsequent numbers are stored in a buffer. The reordering unit 12 sets the timer and enters the standby mode for a predetermined time. The timer is turned off upon receipt of the MAC-es frame having a missing number. Then, the reordering unit 12 delivers, to the disassembly unit 11, the MAC-es frame having the missing sequence number and the MAC-es frames of the following numbers accumulated in the buffer and confirmed to have the right order. Thus, even when a data transmission error is detected and the data is retransmitted in the radio section between the mobile terminal and the radio base station, the MAC-es frames are delivered to the disassembly unit 11 in the order of processing by the multiplexer of the mobile terminal 3. In the case where the timer runs out, the reordering unit 12 suspends the standby mode for receiving the MAC-es frame having a missing number. Then, the reordering unit 12 delivers the MAC-es frames thus far accumulated in the buffer and having the continuous sequence numbers to the disassembly unit 11. In other words, the MAC-es frames, absence those of which the standby mode is suspended, are delivered to the disassembly unit 11.

The disassembly unit 11 separates the MAC-d_PDU 104 from the MAC-es frames and transmits it to the RLC protocol unit 10 for processing the high-ranking layers.

The RLC protocol unit 10 executes the process for the high-ranking layers of the MAC. For example, the data transmission is confirmed at the level of MAC-d_PDU 104, i.e. RLC_PDU 103. More specifically, the continuity of the serial numbers inserted in the RLC protocol frame is confirmed, and upon detection of missing data, the RLC protocol unit 30 of the mobile terminal 3 is requested to retransmit the data. As a result, the final data transmission is guaranteed at the level of the RLC_PDU 103 between the RLC protocol unit 30 of the mobile terminal 3 and the RLC protocol unit 10 of the control station 1.

### SUMMARY OF THE INVENTION

According to one aspect of an embodiment, an uplink packet data communication method for transmitting packet data transmitted from a mobile terminal to a control station through a radio base station, comprises:

receiving from a mobile terminal the packet data and a packet frame containing a sequence number indicating the order in which the packet data is generated;

arranging step a plurality of packet frames received for a predetermined period of time to generate a data frame;

inserting in the data frame a data frame error detection code for detecting an error of each of the data frames and a plurality of packet frame error detection codes for detecting an error in each of the plurality of packet frames contained in the data frame;
receiving the data frame from the radio base station;

detecting the presence or absence of an error of each of the plurality of packet frames contained in the data frame, based on the plurality of packet frame error detection codes inserted in the data frame;

separating the packet frame with no error detected therein from the data frame;

detecting a sequence number of the packet frame with an error detected therein;

rearranging the plurality of separated packet frames in order of sequence number;

awaiting a packet frame of a sequence number found missing during rearranging; and

reordering the plurality of separated packet frames, other than packet frames with an error detected therein, in continuous order by sequence number without waiting for the packet frame having a sequence number with an error detected.

According to another aspect of an embodiment, a radio base station receiving uplink packet data transmitted from a mobile terminal to transmit the packet data to a control station, comprises:

a receiving unit receiving packet data and a packet frame containing a sequence number indicating the order in which the packet data is generated;

an arranging unit arranging a plurality of packet frames received for a predetermined period of time by the receiving unit to generate a data frame;

a data frame generating unit inserting in the data frame a data frame error detection code for detecting an error of each of the data frames and a plurality of packet frame error detection codes for detecting an error in each of the plurality of packet frames contained in the data frame; and

a transmitting unit transmitting the data frame to the control station.

According to still another aspect of an embodiment, a control station receiving packet data transmitted from a mobile terminal through a radio base station, comprises:

a receiving unit receiving a data frame from the radio base station;

a frame error detection unit detecting the presence or absence of an error in each of a plurality of packet frames contained in the data frame, based on a plurality of packet frame error detection codes inserted in the data frame;

a data separation unit separating a packet frame with no error detected therein from the data frame;

a sequence number detection unit detecting a sequence number of the packet frame with an error detected therein;

a first processing unit rearranging the plurality of packet frames separated by the data separation unit, in order of sequence number, and waiting for a packet frames of a missing sequence number; and

a second processing unit arranging, in the continuous order by sequence number, the plurality of separated packet frames, other than the packet frame with an error detected therein, without waiting for the packet frame of the sequence number with an error detected by the data separation unit.

### BRIEF DESCRIPTION OF THE DRAWINGS

FIG. 1 is a diagram for briefly explaining data processing according to HSUPA;

FIG. 2 is a block diagram showing an example of a mobile communication system for realizing the data processing operation shown in FIG. 1;

FIG. 3 is a block diagram showing an example of a mobile communication system for realizing a packet data communication method according to an embodiment;

FIG. 4 is a diagram showing the structure of an FP frame transmitted in the mobile communication system shown in FIG. 3;

FIG. 5 is a flowchart for explaining the process in an FP frame generating/transmitting unit and a MAC-es error correction code insertion unit shown in FIG. 3; and

FIG. 6 is a flowchart showing the process executed in a valid/invalid MAC-es frame extraction unit shown in FIG. 3.

### DESCRIPTION OF THE PREFERRED EMBODIMENTS

Embodiments will be explained below with reference to the accompanying drawings. It is important to note that these embodiments are only examples to advise one of ordinary skill in the art of the many advantageous uses of the innovative teachings herein. In general, statements made in the specification of the present application do not necessarily limit any of the various embodiments. Moreover, some statements may apply to some inventive features but not to others. In general, unless otherwise indicated, singular elements may be in plural and vice versa with no loss of generality. In the various views of the drawings, like reference characters designate like or similar parts.

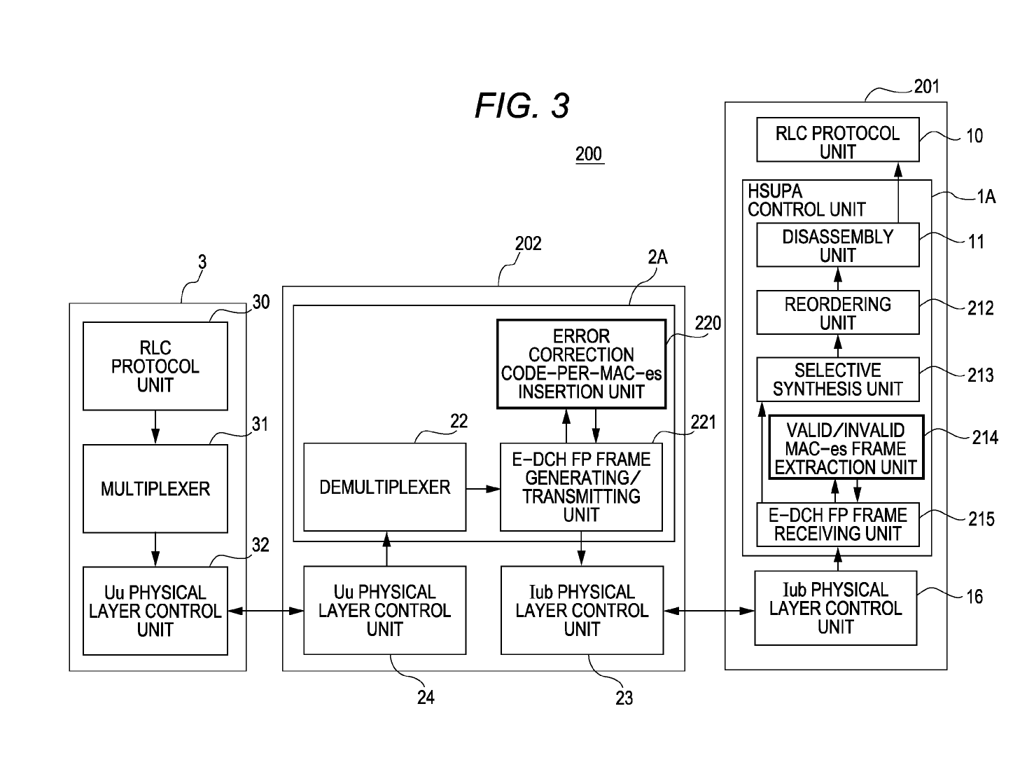

FIG. 3 is a block diagram showing an example of a mobile communication system for realizing a packet data communication method according to an embodiment.

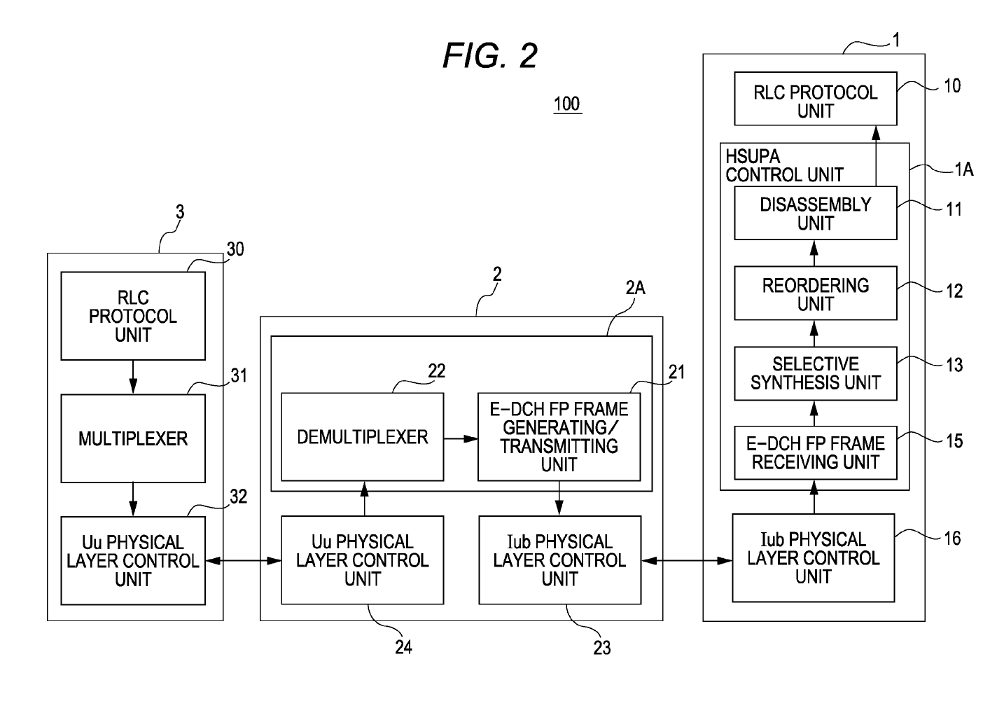

A mobile communication system 200 shown in FIG. 3, like the mobile communication system 100 explained with reference to FIG. 2, includes a control station 201 of FIG. 3, a radio base station 202 of FIG. 3 and a mobile terminal 3 of FIG. 3.

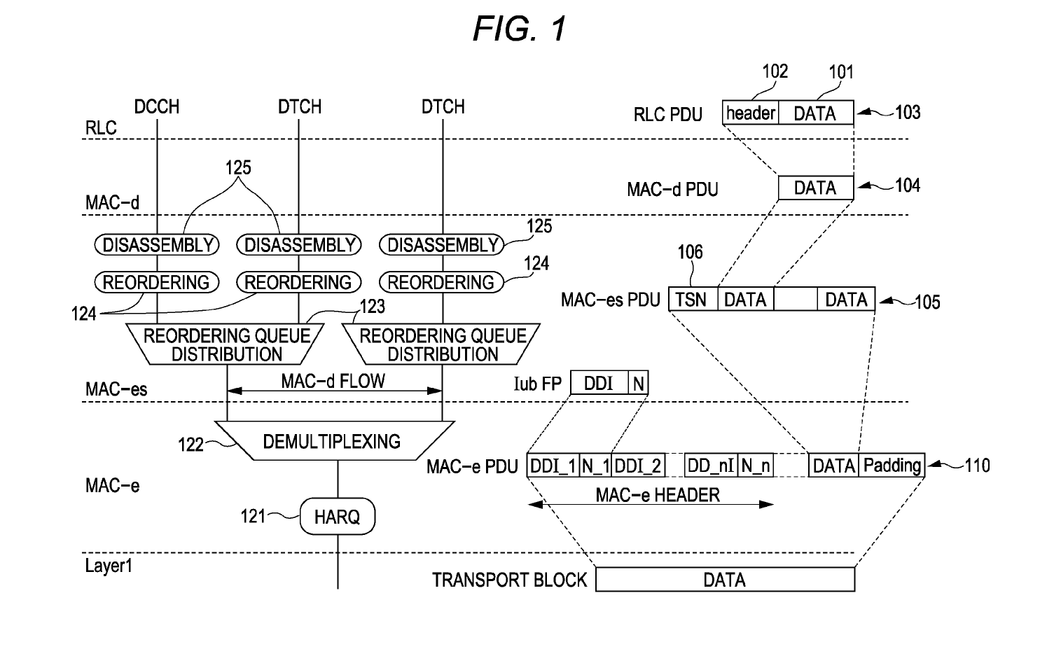

The mobile communication system 200 shown in FIG. 3 is different from the mobile communication system 100 explained with reference to FIG. 2 in that an error correction code-per-MAC-es insertion unit 220 of FIG. 3 is added to the radio base station 202, unit 2A of FIG. 3. Another difference from the mobile communication system 100 is that a valid/invalid MAC-es frame extraction unit 214 of FIG. 3 is added to the control unit 201, HSUPA control unit 1A of FIG. 3. Still another difference from the mobile communication system 100 shown in FIG. 2 lies in the functions of the FP frame generating/transmitting unit 221 of FIG. 3 of the radio base station 202 of FIG. 3 and the reordering unit 212, the selective synthesis unit 213 of FIG. 3 and the FP frame receiving unit 215 of FIG. 3 of the control station 201 of FIG. 3. The other parts of the mobile communication system 200 of FIG. 3, being similar with those of the mobile communication system 100 shown in FIG. 2, are designated by the same reference numerals, respectively, and not explained in detail. The aforementioned different points are mainly explained below. Also, the mobile communication system 200 of FIG. 3, like the mobile communication system 100 shown in FIG. 2, executes the process shown in FIG. 1 on the data of the format shown in FIG. 1, and therefore, FIG. 1 is also referred to for explanation.

The FP frame generating/transmitting unit 221 of the radio base station 202 shown in FIG. 3, like the FP frame generating/transmitting unit 21 shown in FIG. 2, accumulates the MAC-es frames as packet frames separated by a demultiplexer 22 and stores them as data frames in the FP frame. Also, the FP frame generating/transmitting unit 221 of FIG. 3 calculates the CRC (cyclic redundancy check) code for detecting a transmission error in units of FP frames and inserts it in the FP frame. The FP frame generating/transmitting unit 221 of FIG. 3 according to this embodiment further causes the error correction code-per-MAC-es insertion unit 220 of FIG. 3 to calculate a CRC code corresponding to each of the plurality of MAC-es frames accumulated. Then, the FP frame generating/transmitting unit 221 operates in such a manner that the CRC codes determined by calculations in the error correction code-per-MAC-es insertion unit 220 are stored in the same order as the MAC-es frames in a spare extension area at the tail end portion of the FP frame. Then, the FP frame generating/transmitting unit 221 transmits the FP frame from the Iub physical layer control unit 23 of FIG. 3 to the control station 201 of FIG. 3. The demultiplexer 22 of FIG. 3 corresponds to an example of the receiving unit according to this embodiment. Similarly, the combination of the error correction code-per-MAC-es insertion unit 220 and the FP frame generating/transmitting unit 221 corresponds to an example of the data frame generating unit according to this embodiment.

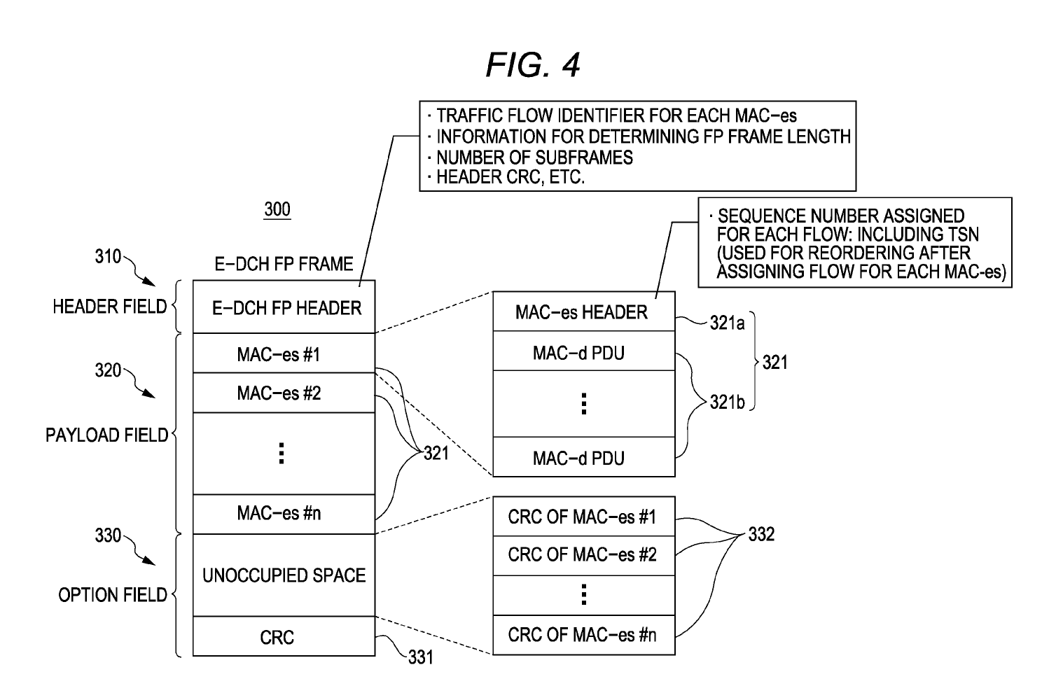

FIG. 4 is a diagram showing the structure of an FP frame transmitted by the mobile communication system shown in FIG. 3.

An FP frame 300 of FIG. 4 includes a header field 310, a payload field 320 and an option field 330.

The header field 310 of FIG. 4 includes a traffic flow identifier for indicating the traffic attribute of each MAC-es frame inserted in the payload field 320, information for determining a frame length of the FP frame 300, the number of subframes, and a header CRC. The subframe is a concept for subdividing the FP frame 300. According to this embodiment, to facilitate the understanding of the structure of the FP frame, the number of the subframes is assumed as unity. In other words, an application is explained with reference to an example in which the FP frame 300 includes one subframe. The header CRC is a code for detecting an error of the header field 310.

The payload field 320 of FIG. 4 includes MAC-es frames 321 in the number of n from MAC-es#1 to MAC-es#n. The MAC-es frames 321, as shown pulled out on the right side in FIG. 4, each include a MAC-es header 321a and a plurality of MAC-d_PDU 321b. The MAC-es header 321a includes a sequence number (TSN) 106 (FIG. 1) indicating the order of the MAC-es frames 321. Incidentally, the sequence number 106 is assigned independently for each traffic flow associated with each MAC-es frame 321. Continuous values are assigned in order as the sequence number 106 to each of the MAC-es frames 321 associated with each traffic flow. The value of the sequence number 106 is assigned continuously over the boundary of the FP frame.

The option field 330 of FIG. 4 has inserted therein a payload CRC 331 for detecting an error of the payload field 320 and n MAC-es CRC's 332 for detecting an error of each of the n MAC-es frames 321 inserted in the payload field 320. The n MAC-es CRC's 332 are arranged in the same order as the n MAC-es frames 321. The MAC-es CRCs 332 are inserted in an unoccupied space of the option field 330. The MAC-es CRC 332, therefore, can be used without changing the structure of the FP frame specified by HSUPA. The payload CRC 331 and the MAC-es CRC 332 are determined by the error correction code-per-MAC-es insertion unit 220.

The error correction code-per-MAC-es insertion unit 220 shown in FIG. 3 determines the CRC code for each of the plurality of MAC-es frames stored in the FP frame by the FP frame generating/transmitting unit 221. More specifically, the error correction code-per-MAC-es insertion unit 220 performs the CRC operation sequentially from the MAC-es frame 321 arranged before the payload field 320. The error correction code-per-MAC-es insertion unit 220 uses the result of the CRC operation of an arbitrary Mth MAC-es frame 321#M (321), i.e. the CRC 332 of the MAC-es#M as an initial value in the CRC operation of the next MAC-es frame 321#M+1 (321). In this way, the CRC is calculated sequentially up to the MAC-es frame 321#n 321 arranged at the end of the payload field 320. As the result of this arithmetic operation, the CRC operation of the data for the whole payload field 320 is performed at the same time. Thus, only the arithmetic operation is required to obtain the CRC for each MAC-es frame 321, and the calculation of the payload CRC 331 of the data for the whole payload field 320 is not required. The detailed procedure for determining the payload CRC 331 and the MAC-es CRC 332 is described later.

The FP frame receiving unit 215 of the control station 201 shown in FIG. 3 receives, from the Iub physical layer control unit 16, the FP frame 300 (FIG. 4) output by the radio base station 202. The FP frame receiving unit 215 confirms whether or not the data of the header field 310 has no transmission error based on the header CRC in the FP frame 300. Thereafter, the FP frame receiving unit 215 confirms the normalcy of the payload field 320 based on the payload CRC 331. According to this embodiment, even upon determination that the payload field 320 of the FP frame has an error, the FP frame receiving unit 215 causes the valid/invalid MAC-es frame extraction unit 214 to extract the sequence number of the normal MAC-es frame and the sequence number of the MAC-es frame having an error. Then, the FP frame receiving unit 215 notifies the selective synthesis unit 213 of the sequence number of the extracted normal MAC-es frame and the sequence number of the MAC-es discarded as an error.

The method in which the valid/invalid MAC-es frame extraction unit 214 of FIG. 3 extracts the sequence number of the normal MAC-es frame and the sequence number for an error will be explained in detail later.

The selective synthesis unit 213 of FIG. 3 confirms the sequence number of the MAC-es frame that is separated by the FP frame receiving unit 215 and distributes according to traffic flow an output, and delivers the MAC-es frame to the reordering unit 212. In the case where the sequence number of the MAC-es frame to be confirmed is the same as that of a previously received MAC-es frame included in the same traffic flow, the particular MAC-es frame to be confirmed is discarded. In the mobile communication system 200 of FIG. 3, a plurality of radio base stations receive the data from the mobile terminal in parallel. However, only the first-arriving one of the plurality of MAC-es frames having the same sequence number is passed through the selective synthesis unit 213. Also, according to this embodiment, the selective synthesis unit 213 manages, by sequence number, the number of times the MAC-es frame is discarded as an error by the FP frame receiving unit 215. A given MAC-es frame, if discarded by the FP frame receiving unit 215 the same number of times as the number of radio base stations connected to the mobile terminal 3 involved, cannot be expected to be retransmitted without the request from the high-ranking layer of the RLC protocol unit 10. In such a case, the reordering unit 212 is notified that the MAC-es frame is discarded due to loss.

The reordering unit 212 of FIG. 3 waits for the MAC-es frame for each traffic flow. The reordering unit 212 rearranges the data in the order of the sequence number. Upon lapse of a predetermined waiting time, the reordering unit 212 gives up on receiving the MAC-es frame having a missing number, and delivers the MAC-es frames accumulated in the buffer to the disassembly unit 11. Further, according to this embodiment, the reordering unit 212 of FIG. 3, upon receipt of the notification from the selective synthesis unit 213 that the MAC-es frame of a given specified sequence number has been discarded due to the loss (for example wired loss) equivalent to the number of the radio base stations, determines that the particular MAC-es frame will no longer arrive. The reordering unit 212 thus gives up on receiving the MAC-es frame of the particular sequence number. In this case the reordering unit 212 delivers the MAC-es frames accumulated in the buffer to the disassembly unit 11 before a predetermined waiting time runs out in the same manner as if the predetermined waiting time had run out.

The combination of the valid/invalid MAC-es frame extraction unit 214 of FIG. 3 and the FP frame receiving unit 215 of FIG. 3 corresponds to an example of the data separation unit according to this embodiment, and the combination of the reordering unit 212 of FIG. 3 and the selective synthesis unit 213 of FIG. 3 corresponds to an example of the reordering unit according to this embodiment.

Now, the uplink packet data communication method for the mobile communication system 200 shown in FIG. 3 will be explained.

The packet data transmission method is explained below along the data flow as an operation of each part of the mobile communication system 200. Each process making up the packet data transmission method corresponds to the operation of each of the parts making up the mobile terminal 3, the radio base station 202 and the control station 201 of the mobile communication system 200.

First, the operation of the mobile terminal 3 is explained.

The uplink packet data is transmitted to the multiplexer 31 as MAC-d_PDU 104 from the RLC protocol unit 30 in charge of the process in the high-ranking MAC layers. The multiplexer 31 multiplexes the data of a plurality of MAC-d_PDU formats 104 thereby to generate a MAC-es frame 105. The multiplexer 31 further multiplexes a plurality of MAC-es frames 105 thereby to generate a MAC-es frame 110. The continuous sequence numbers (TSN) 106 including 0 to 63 are inserted sequentially in the plurality of MAC-es frames 105. In this way, the plurality of MAC-es frames 105 are multiplexed into a MAC-e frame.

The packet data multiplexed into the MAC-e frame 110 by the multiplexer 31 are transmitted by radio communication from the Uu physical layer control unit 32 of the mobile terminal 3 to the Uu physical layer control unit 24 of the radio base station 202. Incidentally, the Uu physical layer control unit 32 of the mobile terminal 3 and the Uu physical layer control unit 24 of the radio base station 202 not only control the radio communication but also confirm the data delivery for each MAC-e frame 110 in this radio section. The Uu physical layer control unit 24 of the radio base station 202 detects an error of the data transmitted thereto. The Uu physical layer control unit 24 of the radio base station 202, upon detection of an error, requests the Uu physical layer control unit 32 of the mobile terminal 3 to retransmit the MAC-e frame in which the error has been detected. The mobile terminal 3 retransmits the requested MAC-e frame to the radio base station 202. As a result, the data drop-off in the radio section is suppressed. Nevertheless, the error detection and the MAC-e frame retransmission consume a considerable length of time. The MAC-e frame is retransmitted, therefore, to the radio base station 202 and the control station 201 later than the succeeding MAC-e frames transmitted during the error detection and retransmission.

Now, the operation of the radio base station 202 is explained.

The MAC-e frame received from the mobile terminal 3 through the radio section is demultiplexed by the demultiplexer 22 into the MAC-es frames 105 (FIG. 1). The MAC-es frames 105 are accumulated in the FP frame generating/transmitting unit 221. Although only one mobile terminal 3 is shown in FIG. 3, the actual radio base station 202 corresponds to a plurality of mobile terminals 3 associated with a plurality of subscribers. The MAC-es frames transmitted from the plurality of mobile terminals 3 are classified by subscriber, i.e. for each of the plurality of mobile terminals 3 and accumulated in the FP frame generating/transmitting unit 221.

In the FP frame generating/transmitting unit 221, the MAC-es frames accumulated by subscriber for each transmission period determined for each subscriber are stored in the FP frame shown in FIG. 4. Each FP frame corresponds to one subscriber, i.e. one mobile terminal.

A CRC code making up an error detection code for detecting an error of the data in transmission is inserted by the error correction code-per-MAC-es insertion unit 220 in the MAC-es frames stored in the FP frame. The process executed by the demultiplexer 22 corresponds to an example of the receiving process according to this embodiment. The process by the error correction code-per-MAC-es insertion unit 220 and the FP frame generating/transmitting unit 221, on the other hand, corresponds to an example of the data frame generating process according to this embodiment. The method of calculating the error detection code is explained in detail below.

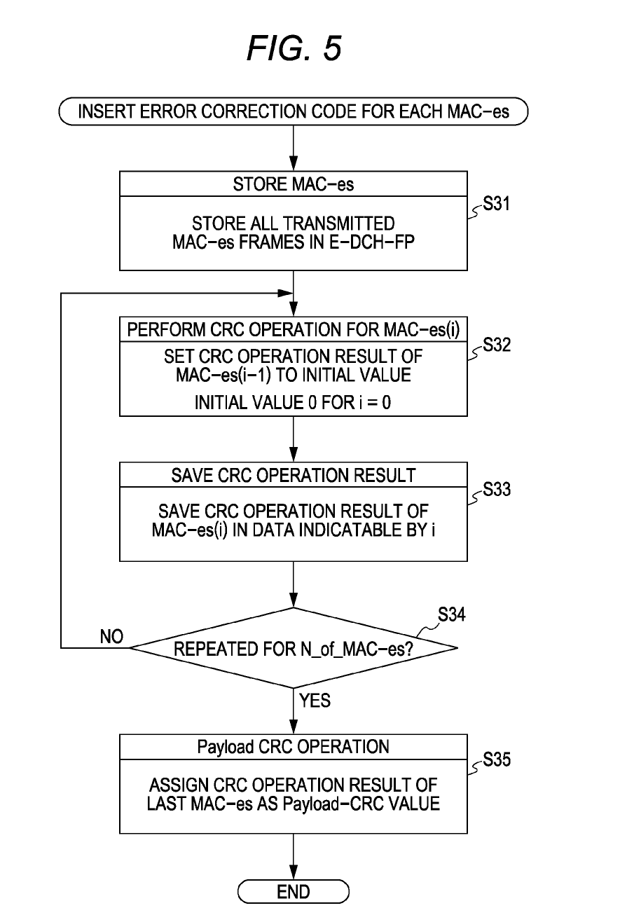

FIG. 5 is a flowchart for explaining the process executed in the FP frame generating/transmitting unit 221 and the error correction code-per-MAC-es insertion unit 220.

The first step of the process shown in FIG. 5 is to store the MAC-es frames (step S31). The MAC-es frames thus accumulated are stored in the FP frame. In the case under consideration, an explanation is made also with reference to FIG. 4 on the assumption that n MAC-es frames including MAC-es#1 to MAC-es#n are stored in the FP frame.

Next, the error correction code-per-MAC-es insertion unit 220 determines the MAC-es(i) by the CRC operation (step S32), where i is a variable indicating a particular MAC-es frame stored. The variable i starts with 0 to enter the process from the MAC-es#1 shown in FIG. 4. The CRC operation is performed on the data of the MAC-es#1 thereby to obtain the value of the CRC code. For this arithmetic operation, the result of the previous CRC operation, i.e. the result of the CRC operation of the MAC-es(i−1) is used as an initial value. This initial value, however, is initialized to 0 for each FP frame. In other words, the CRC operation is performed with i=0, i.e. with the initial value of 0 for MAC-es#1.

Next, the CRC operation result is saved (step S33). The CRC operation result is inserted in the area indexed by the variable i in the option field 330 shown in FIG. 4. The CRC operation result of MAC-es#1 is inserted in the FP frame 300 as the CRC of MAC-es#1 in the option field 330.

The aforementioned CRC operation of the MAC-es(i) and the saving of the CRC operation result are repeated the number of times equal to the number of MAC-es. In other words, the process is repeated for MAC-es#2 to MAC-es#n (step S34). By repeating the process in this way, the CRC for MAC-es#2 to MAC-es#n in the option field 330 shown in FIG. 4 are buried with the CRC code calculated by using each MAC-es frame 321 arranged in the FP frame 300.

Finally, the payload CRC is calculated (step S35). In the aforementioned CRC operation of the MAC-es(i), the result of the previous arithmetic operation is used directly as an initial value of the next arithmetic operation. Therefore, the result of the CRC operation of MAC-es#n is equal to the result of the CRC operation for the whole payload field 320 from MAC-es#1 to MAC-es#n. Thus, the result of the arithmetic operation of the last MAC-es#n is stored in the area of the payload CRC 331. In this way, the arithmetic operation for the payload CRC is used for the CRC arithmetic operation for each MAC-es. The CRC operation has a heavy processing load if executed with software. According to this embodiment, the CRC arithmetic operation for MAC-es is also used for the arithmetic operation of the payload CRC. According to this embodiment, therefore, the value of the CRC arithmetic operation for each MAC-es can be inserted without increasing the processing load.

The FP frame generating/transmitting unit 221 sends the FP frame with the CRC code inserted therein to the Iub physical layer control unit 23. The Iub physical layer control unit 23 transmits the FP frame toward the control station 201. According to this embodiment, an ATM interface of AAL2 is used for the Iub physical layer. The Iub physical layer control unit 23 divides the FP frame into the ATM cells of AAL2, and sends them to the Iub physical layer control unit 16 of the control station 201 by the wired transmission through an ATM network (not shown). One skilled in the art would recognize other transmission mediums may be utilized for transmission to the control station 201. In the ATM transmission, a bit error may occur due to an electromagnetic effect or a part of the ATM cells is discarded depending on the relation between the QoS setting conditions for the ATM network and the propagation delay or fluctuation on the ATM network. The effect of the transmission error occurring during the ATM transmission is reduced by the process of the control station 201.

Next, the operation of the control station 201 is explained.

The Iub physical layer control unit 23 of the control station 201 receives the ATM cells of AAL2 and reassembles the FP frame. The AAL2 uses an index of the head or middle of the FP frame and an index of the end of the frame. In the Iub physical layer control unit 23, the FP frame is reassembled using the particular indexes. The Iub physical layer control unit 23 completes the reassembly by receiving the last ATM cell of AAL2, i.e. the cell containing the index of the end of the FP frame. Then, the Iub physical layer control unit 23 delivers the FP frame to the FP frame receiving unit 215.

In the ATM transmission, a bit error may occur or a part of the ATM cells may be discarded as described above. In such a case, the assembled FP frame is different from the FP frame transmitted from the radio base station 202. This error is detected by detecting an error of the payload of the obtained FP frame based on the payload CRC 331, and recognized as an error in units of FP frames. In the FP frame receiving unit 215 according to this embodiment, however, the three types of loss in the wired transmission described below are assumed. They include (1) a bit error (the length of the received FP frame is equal to the length of the theoretical FP frame), (2) the AAL2 intermediate cell is lost (the received FP frame is shorter than the theoretical FP frame), and (3) the AAL2 last cell is lost (the length of the received FP frame exceeds the length of the theoretical FP frame). In the three types of loss described above, the FP frame receiving unit 215 causes the valid/invalid MAC-es frame extraction unit 214 to restore the data in the FP frame partially.

In the case where the AAL2 cell corresponding to the head of the FP frame is lost other than the three types of loss described above, a CRC error is detected in the FP frame header. In such a case, even the theoretical value of the FP frame length cannot be calculated, and the FP frame is discarded.

The process executed by the valid/invalid MAC-es frame extraction unit 214 and the FP frame receiving unit 215 correspond to an example of the data separation process according to this embodiment.

The process executed by the FP frame receiving unit 215 is explained in more detail. The FP frame receiving unit 215 calculates the theoretical value of the FP header length, calculates the CRC of the FP header field and compares it with the value of the header CRC. In the case where the comparison result is coincident, it indicates that the FP header is normally received. In this case, the theoretical length of the FP payload length and the theoretical value of the option field length are calculated based on the value of each field in the header. The sum of these values is compared with the length of the E-DCH_FP actually received. In the case where the comparison result is coincident, the cell loss described in (2) and (3) above is canceled. In the case where the length of the received E-DCH_FP is shorter, on the other hand, the cell loss described in (2) above is determined as prevailing. In the case where the length of the received E-DCH_FP is longer, the cell loss described in (3) is determined as prevailing. Next, the payload CRC is calculated based on the FP payload length.

According to this embodiment, the valid/invalid MAC-es frame extraction unit 214 performs the CRC operation for each MAC-es, and extracts the sequence number (TSN) of the valid MAC-es frame and the invalid MAC-es frame. Now, the process executed in the valid/invalid MAC-es frame extraction unit 214 is explained in detail.

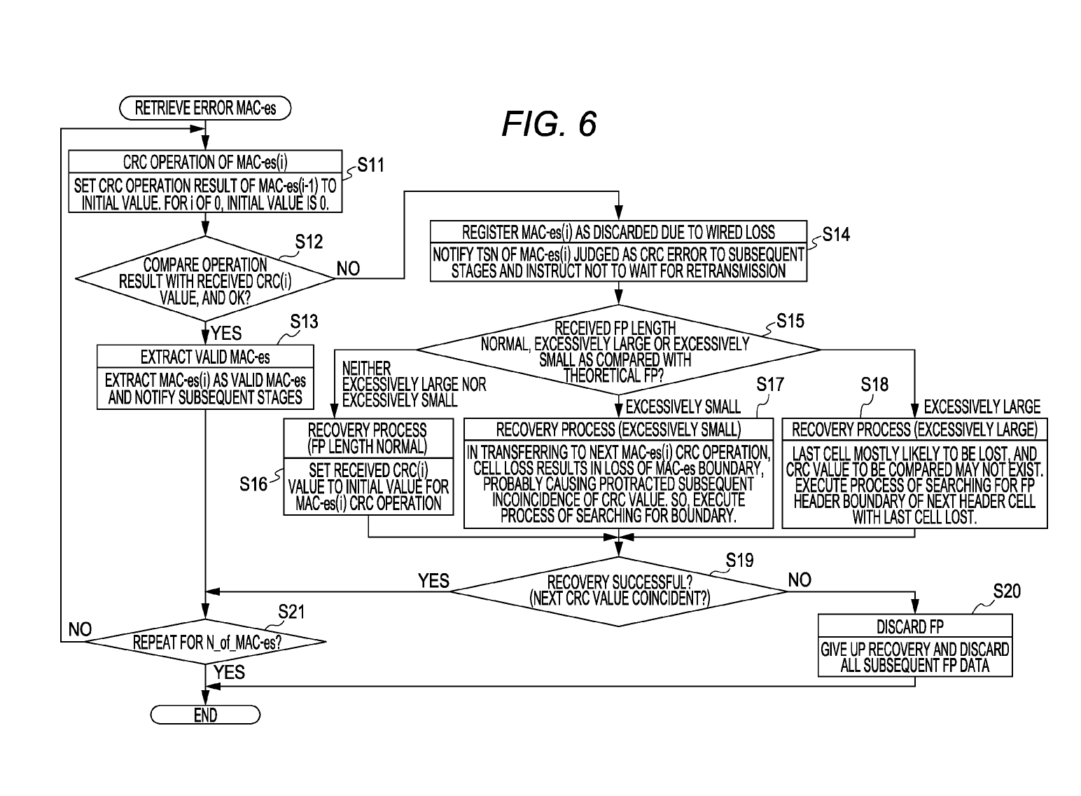

FIG. 6 is a flowchart showing the process executed by the valid/invalid MAC-es frame extraction unit 214 shown in FIG. 3.

The valid/invalid MAC-es frame extraction unit 214 executes the steps, one by one, of the process for a plurality of MAC-es frames arranged in the FP frame.

First, the valid/invalid MAC-es frame extraction unit 214 performs the CRC operation on the MAC-es(i) frame (step S11). The valid/invalid MAC-es frame extraction unit 214 compares the MAC-es(i) frame with a corresponding CRC (step S12). For example, the arithmetic operation is performed with the initial value of the CRC as 0 for the first MAC-es frame (step S11). In the case where the result of the arithmetic operation coincides with the first CRC value of the option field (YES in step S12), the MAC-es frame on which the arithmetic operation has been performed is separated and extracted as a valid frame. The MAC-es frame thus separated and extracted is supplied to the selective synthesis unit 213 (step S13). With the first CRC value as an initial value, the CRC operation is performed for the second MAC-es frame (step S11). This process is repeated to the last MAC-es frame (step S21). The result of the CRC operation for the last MAC-es frame is the same as the result of the CRC operation for the whole payload. The value of the result of the CRC operation for the last MAC-es frame is compared with the value stored at the payload CRC position thereby to confirm the normalcy of the payload as a whole.

The valid/invalid MAC-es frame extraction unit 214, upon detection of an error by the CRC operation for each MAC-es frame, determines that a loss has occurred. The sequence number (TSN) of the MAC-es frame thus checked is recorded (step S14). Incidentally, the sequence number (TSN) itself may include a bit error, and therefore, the accuracy of the value of the sequence number (TSN) is confirmed, for example, by checking to see whether or not the sequence number has a value assumed as a MAC-es frame to be received. As an alternative, the accuracy of the sequence number (TSN) extracted is confirmed by inserting the parity bit of the sequence number in the 3-bit spare region arranged above the sequence number or otherwise. The sequence number of the MAC-es frame with an error detected therein is recorded. Thereafter, determining which one of the loss patterns (1) to (3) described has occurred (step S15), and the recovery process is executed as far as possible.

In the case of the loss pattern (1) (“neither excessively large nor excessively small” in step S15), a bit error has occurred. In the case of the wired loss pattern (1) described above, therefore, the CRC code of the MAC-es corresponding to the MAC-es frame involved is read from the FP frame in place of the result of the CRC operation. With the value thus read as an initial value, the CRC operation is performed for the next MAC-es frame (step S16). In this case, the result of the CRC operation is highly liable to coincide with the CRC code of the MAC-es in the FP frame corresponding to the next MAC-es frame. In the case where they are so coincident (YES in step S19), the next MAC-es frame is regarded as normal. Then, the error detecting operation for the second next MAC-es frame is continued (step S21). In the case of the loss pattern (1) described above, the CRC operation can be performed for each MAC-es frame boundary. In the case of the loss pattern (1), therefore, all the sequence numbers (TSN) with the MAC-es frame as an error can be detected.

In the case of the loss patterns (2) and (3) described above, on the other hand, the expected MAC-es frame length and the actually received frame length are displaced from each other due to the cell loss. In such a case, the process of searching for the next correct MAC-es boundary is required. Until such a boundary is found, all the data are unavoidably determined as invalid. In the boundary searching process, the overage or shortage of the received FP data length with respect to the theoretical FP length is divided by the data length per cell of AAL2 to calculate an estimated value of the number of extraneous or deficient cells in advance.

In the case of the intermediate cell loss (2) described above (“excessively small” in step S15), the data is read from the position added by the data length of the estimated deficient cells. Based on the necessary conditions, it is determined whether or not the value of the sequence number (TSN) at the head of the MAC-es frame that has been read coincides with the expected sequence number (TSN) range (step S17). Further, the CRC operation is subsequently performed, and in the case where the results thereof are coincident (YES in step S19), the sufficient conditions are regarded as fulfilled and the recovery determined as successful. In the case where they are not so coincident, on the other hand, a similar process is repeated by further adding the data length of deficient cells by one cell. This process is repeated until a predetermined theoretical number of deficient cells is reached.

In the case of the last cell loss in (3) above (“excessively large” in step S15), on the other hand, the result of the CRC operation which should be stored in the last cell is faulty. Thus, the FP frame with the AAL2 last cell lost is given up. In order to save the next FP frame, the recovery process is executed by detecting the head position of the particular FP frame (step S18). The data is read from the position one cell forward of the position where the cell number estimated as excessively large is reduced from the theoretical FP length. Then, a CFN (connection frame number) value expected to have been transmitted by the radio base station 202 is searched for each octet. With reference to the position where the CFN value is retrieved, the FP header length is determined, and the header CRC calculated. Once the header CR comes to coincide, the recovery is regarded as successful, and the process for determining the payload length is started. The subsequent process is similar to the aforementioned one. According to related art, in the case of the last cell loss in (3) above, the result of the CRC operation which should be stored in the last cell is faulty, and therefore, the particular frame is unavoidably discarded. Further, in the case of the last cell loss in (3) above, the interval before the arrival of the succeeding AAL2 last cell is regarded as one FP frame, and all the plurality of FP frames in the process are unavoidably discarded. In the process according to this embodiment, on the other hand, the FP frame next to the one containing the lost cell can be saved.

In the case where the header CRC fails to coincide, the CFN value is further searched. In the case where the header CRC still fails to coincide after further execution of the aforementioned process by one cell, not only the last cell of the previous FP frame but also the head cell of the next FP frame are determined as lost and the recovery process determined as a failure.

As described above, in the case where an error is detected in units of FP frame by error detection based on the payload CRC 331, the valid/invalid MAC-es frame extraction unit 214 detects the presence or absence of an error for each MAC-es frame based on the MAC-es CRC 332. The valid MAC-es frame with no error detected therein is separated, while the sequence number (TSN) of the invalid MAC-es frame having an error therein is detected. The sequence number (TSN) thus detected, together with the information that a payload CRC error has occurred, is notified to the selective synthesis unit 231.

In the selective synthesis unit 213, the sequence number (TSN) of the MAC-es frame received first of all the plurality of radio base stations 202 connected to one mobile terminal 3 through radio communication, i.e. the plurality of E-DCH connections, is managed as a received sequence number. The selective synthesis unit 213 sends the MAC-es frame of the particular sequence number (TSN) to the reordering unit 212 in the subsequent stage while at the same time discarding the later-received MAC-es frame of the same sequence number (TSN). According to this embodiment, the selective synthesis unit 213 further determines whether or not the MAC-es frame of a specified sequence number (TSN) can no longer be received or not, due to the discarding caused by loss. More specifically, the reordering unit 212 is caused to manage how many anomalous MAC-es frames of the same sequence number (TSN) have arrived at the control station 201. As soon as the number of the anomalous MAC-es frames that have arrived reaches the number of the E-DCH connections in operation, the selective synthesis unit 213 determines that the MAC-es frame of the sequence number (TSN) involved can no longer be received. Then, the selective synthesis unit 213 requests the reordering unit 212 in the subsequent stage to start the time-out operation for the MAC-es frame of the particular sequence number (TSN).

The reordering unit 212 waits for the MAC-es frame for each traffic flow and executes the process of rearranging the MAC-es frames in the order of the sequence number (TSN). The reordering unit 212, upon receipt of the sequence numbers (TSN) in right order, delivers the MAC-es frames to the disassembly unit 11. The disassembly unit 11 sends the MAC-es frames to the RLC protocol unit 10 in a high-ranking layer. Upon detection of a drop-off of the sequence number (TSN), i.e. a missing number, however, the reordering unit 212 sets the timer for a predetermined time, and begins to wait for the arrival of the MAC-es frame having the oldest one of the missing sequence numbers (TSN). Thereafter, the timer is turned off as soon as the MAC-es frame of the corresponding number is received. Then, the MAC-es frames of the succeeding sequence numbers (TSN) the orderly receipt of which has been confirmed are sequentially delivered to the disassembly unit 11. Also, as soon as the time goes out, the receipt is given up and the MAC-es frames are delivered to the disassembly unit 11 until the arrival of the next sequence number detected as missing. Further, the reordering unit 212 according to this embodiment, upon receipt of an instruction from the selective synthesis unit 213 to start the time-out process, determines that the MAC-es frame of the corresponding sequence number no longer arrives. Then, the time-out process is started to execute the process of giving up the receipt of the MAC-es frame of the corresponding number. In the related art, a case where a transmission error occurs in the section between the radio base station 202 and the control station 201 and the MAC-es frame is discarded cannot be distinguished from a case in which the MAC-es frame is late in arrival due to the retransmission caused by the transmission error in the radio section. For this reason, assuming that the MAC-es is late in arrival, the notification to the subsequent steps is made only after waiting for the MAC-es frame of a missing number for a predetermined time-out limit. According to this embodiment, on the other hand, the standby state for time-out period is omitted and the succeeding MAC-es frames with a MAC-es frame missing can be transmitted earlier to the subsequent process. The reordering unit 212 and the selective synthesis unit 213 correspond to an example of the reordering process according to this embodiment.

The RLC protocol unit 10 confirms the data in the form of the RLC_PDU 103 (FIG. 1) sent from the disassembly unit 11. The RLC protocol unit 10, upon detection that the data is missing, requests the RLC protocol unit 10 of the mobile terminal 3 to retransmit the data. According to this embodiment, upon occurrence of a transmission error in the wired section, the valid/invalid MAC-es frame extraction unit 214 and the FP frame receiving unit 215 detect the sequence number of the MAC-es frame containing an error. In the reordering unit 212, the standby for the packet frame having this sequence number is omitted. As a result, the high-ranking RLC protocol unit 10 can request the RLC protocol unit 10 of the mobile terminal 3 to transmit the data as soon as possible.

The embodiment described above is explained with reference to a case in which ATM is employed as an example of the Iub physical layer. Nevertheless, this embodiment is not limited to such a configuration, and a choice is available in which the IP network is used for the Iub physical layer in 3GPP. The loss equivalent to (1) in the Iub physical layer with the IP network can be considered similar to that of the ATM. The loss in (2) and (3) above, on the other hand, is considered to correspond to a case in which the reassembly ends in a failure for the IP frame with the packet group in the form of IP fragments partly lost. As a result, this embodiment is applicable also to a case in which the IP network is used, for example, as an Iub physical layer.

According to the embodiment described above, the number of subframes of the FP frame is unity, and each FP frame having mounted thereon one subframe for each E-DCH FP transmission period of the radio base station is transmitted. This embodiment, however, is not limited to this configuration. In an application with a plurality of subframes mounted in one FP frame, for example, the FP frame including a plurality of subframes can be handled by determining the CRC value of each subframe in place of the CRC value for each MAC-es.

As described above, according to this embodiment, the amount of the packet frames retransmitted to the control station from a mobile terminal through a radio base station is reduced. As a result, the transmission efficiency is improved between the mobile terminal and the radio base station and between the radio base station and the control station. Further, since the standby of the packet frame containing an error is omitted, the overall propagation time before the packet frame free of an error is sent to the control station is finally shortened for an improved transmission efficiency.

In an embodiment of the present invention, some or all of the method components are implemented as a computer executable code. Such a computer executable code contains a plurality of computer instructions that when performed in a predefined order result with the execution of the tasks disclosed herein. Such computer executable code may be available as source code or in object code, and may be further comprised as part of, for example, a portable memory device or downloaded from the Internet, or embodied on a program storage unit or computer readable medium. The principles of the present invention may be implemented as a combination of hardware and software and because some of the constituent system components and methods depicted in the accompanying drawings may be implemented in software, the actual connections between the system components or the process function blocks may differ depending upon the manner in which the present invention is programmed.

The computer executable code may be uploaded to, and executed by, a machine comprising any suitable architecture. Preferably, the machine is implemented on a computer platform having hardware such as one or more central processing units (“CPU”), a random access memory (“RAM”)), and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

The functions of the various elements shown in the figures may be provided through the use of dedicated hardware as well as hardware capable of executing appropriate software. When provided by a processor, the functions may be provided by a single dedicated processor, by a single shared processor, or by a plurality of individual processors, some of which may be shared. Explicit use of the term “processor” or “controller” should not be construed to refer exclusively to hardware capable of executing software, and may implicitly include, without limitation, digital signal processor hardware, ROM, RAM, and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. An uplink packet data communication method for transmitting packet data transmitted from a mobile terminal to a control station through a radio base station, said packet data communication method comprising:
receiving packet data and a packet frame containing a sequence number indicating an order in which the packet data is generated;
arranging a plurality of packet frames received for a predetermined period of time to generate a data frame;
inserting in the data frame a data frame error detection code for detecting an error of each of the data frames and a plurality of packet frame error detection codes for detecting an error in each of the plurality of packet frames contained in the data frame;
transmitting the data frame to the control station;
detecting the presence or absence of an error of each of the plurality of packet frames contained in the data frame received at the control station, based on the plurality of packet frame error detection codes inserted in the data frame;
separating a packet frame with no error detected therein from the data frame;
detecting a sequence number of a packet frame with an error detected therein;
rearranging the plurality of separated packet frames in order of sequence number;
awaiting the packet frame of a sequence number found missing in the rearranging; and
reordering the plurality of separated packet frames, other than the packet frames with an error detected therein, in a continuous order by sequence number without waiting for the packet frame having a sequence number with an error detected during separating.

2. The packet data communication method according to claim 1, wherein the inserting further includes inserting a CRC code as the packet frame error detection code and the data frame error detection code.

3. The packet data communication method according to claim 1, wherein the inserting further includes sequentially generating the plurality of packet frame error detection codes contained in the data frame with the packet frame error detection code generated immediately before as an initial value, and generating the data frame error detection code based on the packet frame error detection code corresponding to the last packet frame contained in the data frame.

4. The packet data communication method according to claim 1, wherein the receiving further includes receiving, as the packet frame, the MAC-es_PDU specified by HSUPA (high speed uplink packet access) standardized by the Release 6 specification issued by 3GPP (3rd generation partnership project), and
the inserting further includes generating an E-DCH_FP frame specified by the HSUPA as the data frame.

5. A radio base station receiving uplink packet data transmitted from a mobile terminal to transmit the packet data to a control station, said radio base station comprising:
a receiving unit receiving, from the mobile terminal, the packet data and a packet frame containing a sequence number indicating the order in which the packet data is generated;
an arranging unit arranging a plurality of packet frames received for a predetermined period of time by the receiving unit to generate a data frame; and
a data frame generating unit inserting in the data frame a data frame error detection code for detecting an error of each of the data frames and a plurality of packet frame error detection codes for detecting an error in each of the plurality of packet frames contained in the data frame.

7. The radio base station of claim 5, wherein the plurality of packet frame error detection codes are stored in the same order as the plurality of packet frames.

8. The radio base station of claim 5, wherein the plurality of packet frame error detection codes are stored in an option field of the data frame.

9. The radio base station of claim 5 further includes a transmitter transmitting the data frame to the control station.

10. The radio base station of claim 5, wherein the data frame generating unit sequentially generates the plurality of packet frame error detection codes contained in the data frame with the packet frame error detection code generated immediately before as an initial value, and generates the data frame error detection code based on the packet frame error detection code corresponding to the last packet frame contained in the data frame.

11. A control station receiving packet data transmitted from a mobile terminal through a radio base station, said control station comprising:
a receiving unit receiving a data frame from the radio base station;
a frame error detection unit detecting the presence or absence of an error in each of a plurality of packet frames contained in the data frame, based on a plurality of packet frame error detection codes inserted in the data frame;
a data separation unit separating a packet frame with no error detected therein from the data frame;
a sequence number detection unit detecting a sequence number of a packet frame with an error detected therein;
a first processing unit rearranging the plurality of packet frames separated by the data separation unit, in order by sequence number, and waiting for a packet frame of a missing sequence number; and
a second processing unit arranging, in a continuous order by sequence number, the plurality of separated packet frames, other than the packet frame with an error detected therein, without waiting for the packet frame of the sequence number with an error detected by the data separation unit.

12. The control station of claim 11, wherein the plurality of packet frame error detection codes are stored in the same order as the plurality of packet frames.

13. The control station of claim 11, wherein the plurality of packet frame error detection codes are stored in an option field of the data frame.

14. The control station of claim 11, wherein a number of same sequence number packet frames having errors is counted and compared to a number of connections to the mobile terminal.
